(19) United States
(12) Patent Application Publication
(10) Pub. No.: US 2008/0210743 A1
(43) Pub. Date: Sep. 4, 2008

(54) PROCESS OF FABRICATING STACK COMPONENT

(75) Inventors: Ming-Tsung Lee, Taoyuan Hsien (TW); Chen-Yu Yu, Taoyuan Hsien (TW); Kai-Hung Huang, Taoyuan Hsien (TW); Lin-Hsien Hu, Taoyuan Hsien (TW)

Correspondence Address: KIRTON AND MCCONKIE, 60 EAST SOUTH TEMPLE,, SUITE 1800, SALT LAKE CITY, UT, 84111, US

(73) Assignee: DELTA ELECTRONICS, INC., Taoyuan Hsien (TW)

(21) Appl. No.: 11/854,681

(22) Filed: Sep. 13, 2007

(30) Foreign Application Priority Data
Mar. 2, 2007 (TW) 096107287

(51) Int. Cl. B23K 1/00; B23K 31/02; B29C 65/00; H01R 43/00

(52) U.S. Cl. 228/260; 156/60; 228/244; 228/259; 29/825

(57) ABSTRACT

A process of fabricating a stack capacitor includes the following steps. First of all, multiple energy storage units having respective first electrodes and second electrodes at opposite sides are provided. These energy storage units are then stacked to have the first electrodes contact with each other and the second electrodes contact with each other, wherein the energy storage units are initially positioned by a fastening member. Next, the first electrodes are bonded together via a first conductive layer and the second electrodes are bonded together via a second conductive layer, thereby fabricating the stack component.

### FIELD OF THE INVENTION

The present invention relates to a process of fabricating an electronic component, and more particularly to a process of fabricating a stack component.

### BACKGROUND OF THE INVENTION

With increasing of electronic industries, the electronic devices are developed toward minimization, high operating speed and increasing integration level. Due to the reduced size, many electronic components are packaged in a stacked form. Take a capacitor for example. For increasing the capacitance and reducing the layout area of the capacitor on the circuit board, a stack capacitor was developed.

FIG. 1(a) is a flowchart illustrating a process of fabricating a conventional stack capacitor. FIG. 1(b) is a schematic cross-sectional view of a conventional stack capacitor. First of all, multiple energy storage units 10 are provided (Step S11). Then, the first electrode 101 and the second electrode 102 of each energy storage unit 10 are respectively bonded to the first metallic terminal 11 and the second metallic terminal 12 via a soldering material 13, thereby forming the stack capacitor 1 (Step S12). Afterwards, the bottom surfaces of the first metallic terminal 11 and the second metallic terminal 12 are fixed on the circuit board 2 via a soldering material 14 according to a surface mount technology, thereby forming the resulting structure of FIG. 1(b) (Step S13).

During the process of welding the first electrodes 101 and the second electrodes 102 of these energy storage units 10 to the first metallic terminal 11 and the second metallic terminal 12, the first electrodes 101 need to be precisely aligned with the first metallic terminal 11 and/or the second electrodes 102 need to be precisely aligned with the second metallic terminal 12. If the alignment is not proper, the amount of the soldering material 13 is insufficient and thus the solderability of the soldering material 13 is unacceptable. Under this circumstance, the first metallic terminal 11 and the second metallic terminal 12 fail to be firmly bonded to the energy storage units 10.

Moreover, the above fabricating process is applicable to large-sized stack capacitors. As for small-sized or medium-sized stack capacitors, the volume of the individual energy storage unit 10 is very small and it is difficult to produce the metallic terminals 11 and 12. That is, the process of welding the first electrodes 101 and the second electrodes 102 of these two energy storage units 10 to the first metallic terminal 11 and the second metallic terminal 12 is very complicated.

Please refer to FIG. 1(b) again. When the stack capacitor 1 is fabricated, the first metallic terminal 11 and the second metallic terminal 12 are firstly bonded to the first electrodes 101 and the second electrodes 102 of the energy storage units 10 and then fixed on the circuit board 2 via the soldering material 14. As a consequence, a great amount of metallic material is consumed to produce the first metallic terminal 11 and the second metallic terminal 12.

Furthermore, in order to fabricate stack capacitors complying with different size specifications, it is required to make a variety of molds to produce corresponding metallic terminals 11 and 12 and thus the conventional process is not cost-effective. In addition, this conventional process fails to be automatically implemented and thus time-consuming.

Therefore, there is a need of providing a process of fabricating medium- or small-sized stack components in a simplified manner.

### SUMMARY OF THE INVENTION

It is an object of the present invention to provide a process of fabricating a medium- or small-sized stack component in a simplified manner.

Another object of the present invention provides a process of fabricating a medium- or small-sized stack component having enhanced solderability and more precise alignment.

In accordance with an aspect of the present invention, there is provided a process of fabricating a stack capacitor. First of all, at the step (a), multiple energy storage units having respective first electrodes and second electrodes at opposite sides are provided. These energy storage units are then stacked to have the first electrodes contact with each other and the second electrodes contact with each other, wherein the energy storage units are initially positioned by a fastening member. Next, at the step (b), the first electrodes are bonded together via a first conductive layer and the second electrodes are bonded together via a second conductive layer, thereby fabricating the stack component.

In an embodiment, the fastening member includes a horizontal plate and at least two clamp arms, and the clamp arms are substantially perpendicular to the horizontal plate.

In an embodiment, the horizontal plate is placed on a top surface of the combination of the energy storage units, and at least two sidewalls of the combination of the energy storage units are clamped by the clamp arms.

In an embodiment, the step (b) includes sub-steps of: (b1) providing a circuit board having the first conductive layer and the second conductive layer corresponding to the first electrodes and the second electrodes, respectively; (b2) placing the combination of the energy storage units on the circuit board such that the first electrodes and the second electrodes are in contact with the first conductive layer and the second conductive layer, respectively; and (b3) fixing the combination of the energy storage units on the circuit board by reflow-soldering the first electrodes and the second electrodes on the first conductive layer and the second conductive layer, respectively.

In an embodiment, the circuit board further includes an adhesive thereon for facilitating fixing the combination of the energy storage units on the circuit board.

In an embodiment, the fastening member is a jig tool having a receiving portion in a surface thereof. The step (b) includes sub-steps of: (b1) receiving the combination of the energy storage units within the receiving portion of the jig tool to initially position the energy storage units, in which the first electrodes are exposed; (b2) dip-soldering the first conductive layer on the first electrodes; (b3) removing the combination of the energy storage units, whose first electrodes have been bonded together via the first conductive layer, from the receiving portion of the jig tool; (b4) receiving the combination of the energy storage units within the receiving portion of the jig tool to initially position the energy storage units, in which the second electrodes are exposed; (b5) dip-soldering the second conductive layer on the second electrodes; and (b6) removing the combination of the energy storage units, whose second electrodes have been bonded together via the second conductive layer, from the receiving portion of the jig tool.

In an embodiment, the step (a) includes sub-steps of: (a1) providing a base having a recess; (a2) partially receiving a first energy storage unit in the recess of the base; (a3) successively stacking the remaining energy storage units on the first energy storage unit to have the first electrodes contact with each other and the second electrodes contact with each other, wherein an adhesive is applied on every two adjacent energy storage units; (a4) hardening the adhesive to initially bond the multiple energy storage units together; and (a5) removing the combination of the energy storage units from the base.

In an embodiment, the fastening member is a jig tool having a hollow portion. The step (b) includes sub-steps of: (b1) receiving the combination of the energy storage units within the hollow portion of the jig tool to initially position the energy storage units, in which the first electrodes and the second electrodes are exposed; (b2) dip-soldering the first conductive layer and the second conductive layer on the first electrodes and the second electrodes, respectively; and (b3) removing the combination of the energy storage units, whose first electrodes and second electrodes have been bonded together via the first conductive layer and the second conductive layer, from the hollow portion of the jig tool.

In an embodiment, the step (a) includes sub-steps of: (a1) providing a base having a recess; (a2) partially receiving a first energy storage unit in the recess of the base; (a3) successively stacking the remaining energy storage units on the first energy storage unit to have the first electrodes contact with each other and the second electrodes contact with each other, wherein an adhesive is applied on every two adjacent energy storage units; (a4) hardening the adhesives to initially bond the multiple energy storage units together; and (a5) removing the combination of the energy storage units from the base.

In an embodiment, the fastening member is a circuit board having a first contact pad and a second contact pad corresponding to the first electrodes and the second electrodes, respectively.

In an embodiment, the step (a) includes sub-steps of: (a1) applying an adhesive on the circuit board and between the first contact pad and the second contact pad; (a2) fixing a first energy storage unit on the circuit board via the adhesive; (a3) successively stacking the remaining energy storage units on the first energy storage unit to have the first electrodes contact with each other and the second electrodes contact with each other, wherein an adhesive is applied on every two adjacent energy storage units; and (a4) hardening the adhesives to initially bond the multiple energy storage units together.

In an embodiment, the step (b) includes sub-steps of: (b1) turning the combination of the energy storage units and the circuit board upside-down; and (b2) dip-soldering or wave-soldering the first conductive layer and the second conductive layer on the first electrodes and the second electrodes, respectively.

Preferably, the stack component is a stack capacitor.

Preferably, the stack component is a stack ceramic capacitor.

In accordance with another aspect of the present invention, there is provided a process of fabricating a stack capacitor. First of all, at the step (a), multiple energy storage units having respective first electrodes and second electrodes at opposite sides are provided. These energy storage units are then stacked to have the first electrodes contact with each other and the second electrodes contact with each other, wherein the energy storage units are initially positioned by a fastening member. Next, at the step (b), the first electrodes are bonded together via a first conductive layer and the second electrodes are bonded together via a second conductive layer, thereby fabricating the stack component. Finally, at the step (c), the fastening member is removed from the stack component.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1(a) is a flowchart illustrating a process of fabricating a conventional stack capacitor;

FIG. 1(b) is a schematic cross-sectional view of a conventional stack capacitor;

FIG. 2 is a flowchart illustrating a process of fabricating a stack capacitor of the present invention;

FIGS. 3(a)˜3(d) schematically illustrate a process of fabricating a stack component according to a first preferred embodiment of the present invention;

FIGS. 4(a)˜4(l) schematically illustrate a process of fabricating a stack component according to a second preferred embodiment of the present invention; and

FIGS. 5(a)˜5(e) schematically illustrate a process of fabricating a stack component according to a third preferred embodiment of the present invention.

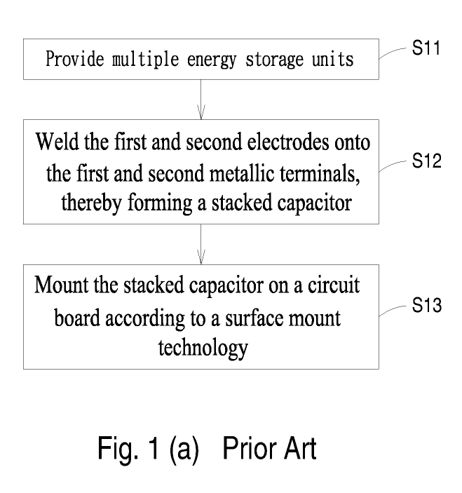

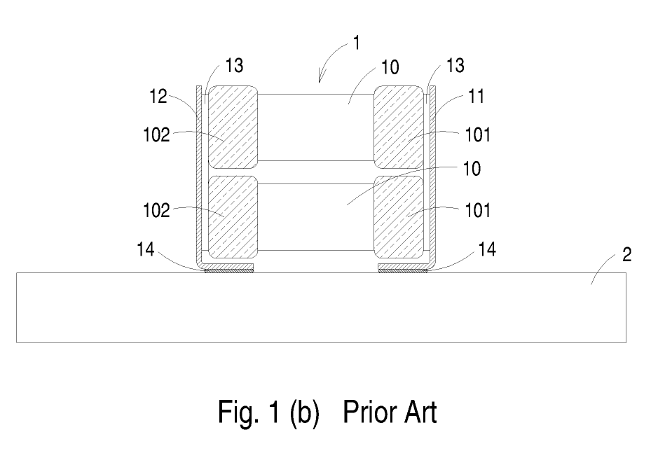

### DETAILED DESCRIPTION OF THE PREFERRED EMBODIMENT

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

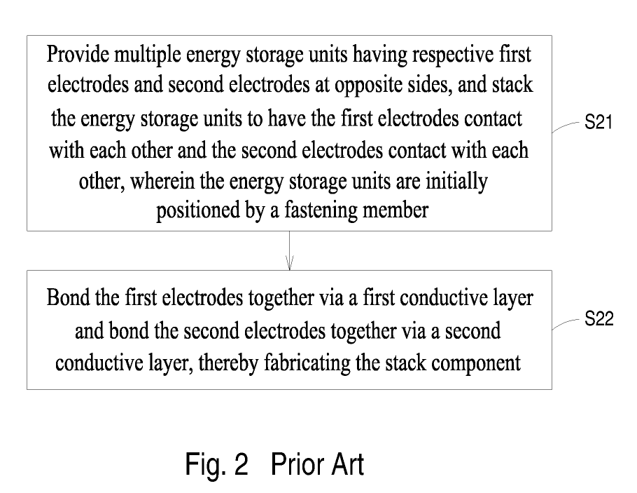

Referring to FIG. 2, a flowchart of a process of fabricating a stack capacitor according to the present invention is illustrated. First of all, multiple energy storage units having respective first electrodes and second electrodes at opposite sides are provided. These energy storage units are then stacked to have the first electrodes contact with each other and the second electrodes contact with each other, wherein the energy storage units are initially positioned by a fastening member (Step S21). Next, the first electrodes are bonded together via a first conductive layer and the second electrodes are bonded together via a second conductive layer, thereby fabricating the stack component (Step S22). An exemplary stack component includes but is not limited to a stack capacitor such as a stack ceramic capacitor.

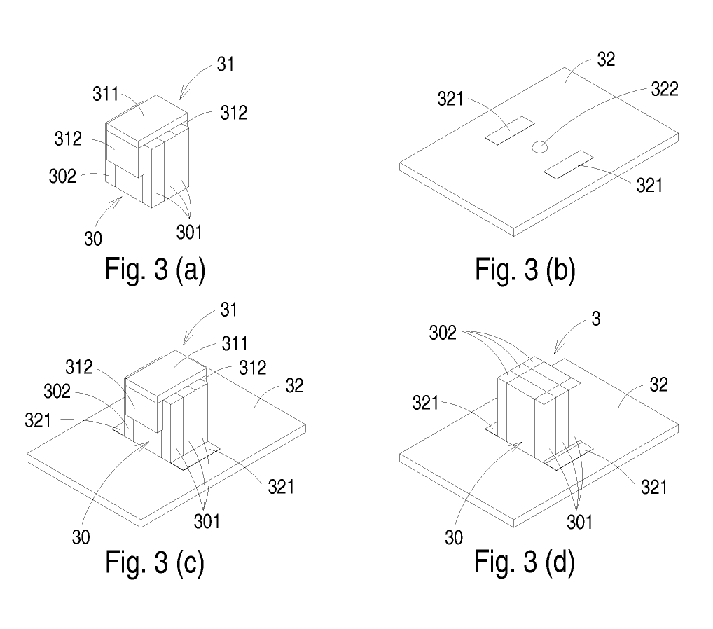

Hereinafter, a process of fabricating a stack component according to a first preferred embodiment of the present invention will be illustrated as follows with reference to FIGS. 3(a)˜3(d). First of all, multiple (e.g. three) energy storage units 30 and a fastening member 31 are provided. The energy storage units 30 are substantially rectangular solids. Each energy storage unit 30 includes a first electrode 301 and a second electrode 302 at bilateral sides thereof. Depending on the users' requirements, the number of the energy storage units 30 included in the stack component 3 may be varied. The fastening member 31 includes a horizontal plate 311 and two clamp arms 312, which are substantially perpendicular to the horizontal plate 311. Preferably, the fastening member 31 is made of a high temperature resistant material.

Next, these energy storage units 30 are stacked, in which the first electrodes 301 are contacted with each other and the second electrodes 302 are contacted with each other. In addition, the horizontal plate 311 of the fastening member 31 is placed on the top surface of the combination of the energy storage units 30 such that bilateral sides of the combination of the energy storage units 30 are clamped by the clamp arms 312 of the fastening member 31. As a consequence, the fastening member 31 may facilitate tight contact of these energy storage units 30, as can be seen in FIG. 3(a).

Next, a circuit board 32 is provided. As shown in FIG. 3(b), the circuit board 32 has thereon two conductive layers 321 corresponding to the first electrodes 301 and the second electrodes 302. The conductive layers 321 are made of conductive material. Optionally, an adhesive 322 is coated on the circuit board 32 between these two conductive layers 321.

Next, as shown in FIG. 3(b), the first electrodes 301 and the second electrodes 302 of the energy storage units 30, whose upper peripheries have been fastened by the fastening member 31, are in contact with respective conductive layers 321. In addition, the combination of the energy storage units 30 is fixed on the circuit board 32 via the adhesive 322.

For facilitating fixing the combination of the energy storage units 30 on the circuit board 32, the conductive layers 321 are for example solder paste layers and/or the adhesive 322 is made of room temperature vulcanizable (RTV) silicone rubber or phenolic formaldehyde resin. After the combination of the energy storage units 30 is precisely placed on the circuit board 32, the stacked energy storage units 30 and the circuit board 32 are subject to a reflow soldering process and an adhesive hardening process. As a result, the conductive layers 321 (e.g. solder paste layers) are molten and then cooled to bond the first electrodes 301 and the second electrodes 302 of the energy storage units 30 onto the circuit board 32. In addition, the adhesive 322 is harden to the bond the bottom surface of the combination of the energy storage units 30 onto the circuit board 32. Under this circumstance, the energy storage units 30 are fixed onto and electrically connected to the circuit board 32. Optionally, the fastening member 31 may be removed and thus a stack component 3 is mounted on the circuit board 31, as shown in FIG. 3(d).

It is noted that, however, those skilled in the art will readily observe that numerous modifications and alterations of the fastening member 31 may be made while retaining the teachings of the invention. For example, the fastening member 31 may include a horizontal plate 311 and four clamp arms 312. In addition, the horizontal plate 311 of the fastening member 31 is placed on the top surface of the combination of the energy storage units 30 and four sides of the combination of the energy storage units 30 are clamped by the clamp arms 312 of the fastening member 31.

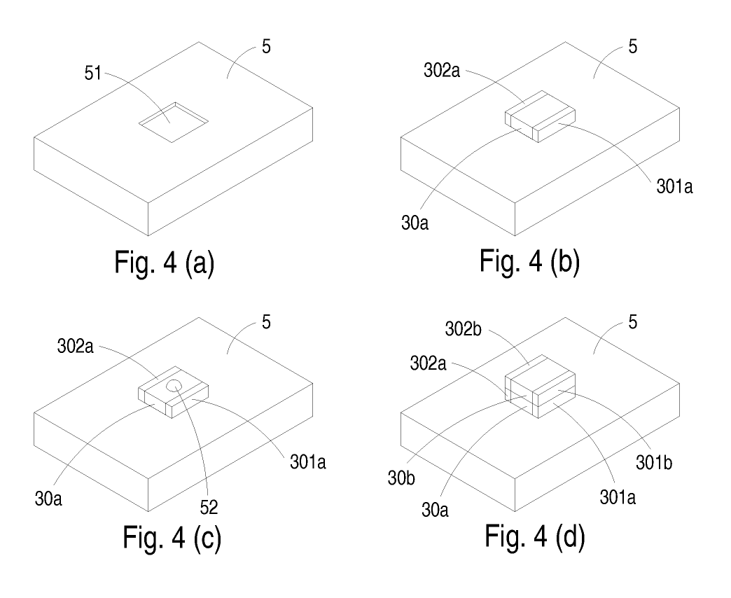

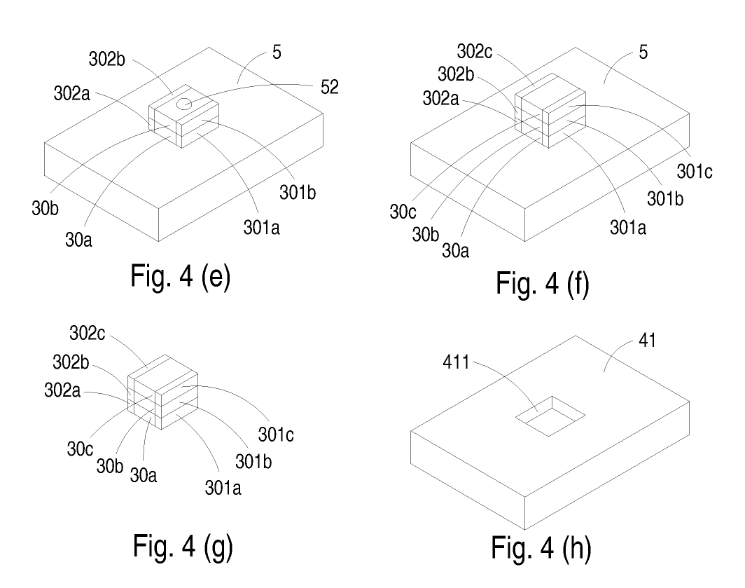

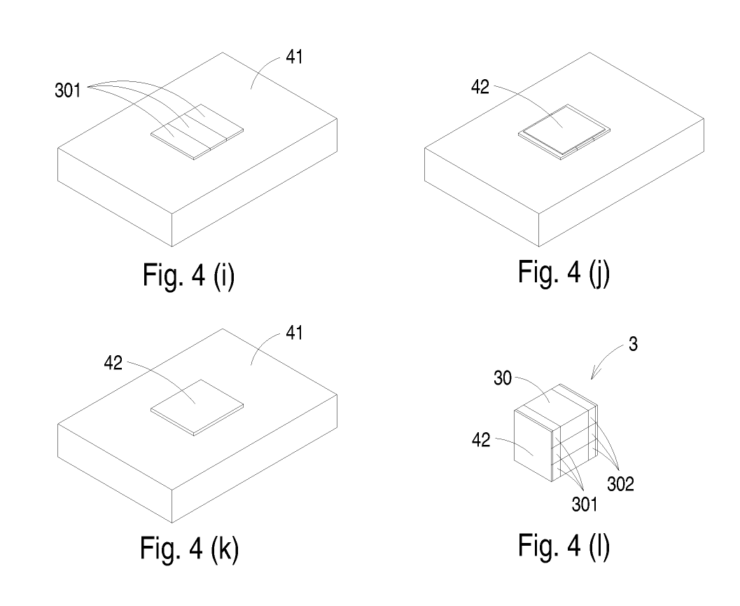

FIGS. 4(a)˜4(l) are schematic views illustrating a process of fabricating a stack component according to a second preferred embodiment of the present invention. The fabricating process principally includes a first stage (as shown in FIGS. 4(a) to 4(g)) and a second stage (as shown in FIGS. 4(h) to 4(l)).

First of all, as shown in FIG. 4(a), a base 5 is provided. The base 5 has a recess 51 in a surface thereof. The size of the recess 51 is substantially identical to that of each energy storage unit 30a. Then, an energy storage unit 30a is partially received in the recess 51 of the base 5. As shown in FIG. 4(b), the energy storage unit 30a has a first electrode 301a and a second electrode 302a, which are disposed on opposite sides of the energy storage unit 30a and parallel with the surface of the base 5. Next, an adhesive 52 is coated on the top surface of the energy storage unit 30a and between the first electrode 301a and the second electrode 302a, as is shown in FIG. 4(c). The adhesive 52 is for example made of room temperature vulcanizable (RTV) silicone rubber or phenolic formaldehyde resin. Then, as shown in FIG. 4(d), another energy storage unit 30b is fixed on the energy storage unit 30a via the adhesive 52. Meanwhile, the first electrode 301b and the second electrode 302b of the energy storage unit 30b are contacted with the first electrode 301a and the second electrode 302a of the energy storage unit 30a. Next, an adhesive 52 is coated on the top surface of the energy storage unit 30b and between the first electrode 301b and the second electrode 302b, as is shown in FIG. 4(e). Then, as shown in FIG. 4(f), a further energy storage unit 30c is fixed on the energy storage unit 30b via the adhesive 52 such that the first electrodes 301a, 301b and 301c are contacted with each other and the second electrodes 302a, 302b and 302c are contacted with each other. The resulting structure of FIG. 4(f) is subject to an adhesive hardening process by thermally or UV curing the adhesive 52. As a result, the energy storage units 30a, 30b and 30c are boned together. Then, the combination of the energy storage units 30a, 30b and 30c are removed from the base 5, as is shown in FIG. 4(g).

In the second stage, a fastening member 41 such as a jig tool (also indicated as 41 herein) is provided. The jig tool 41 has also a receiving portion 411 in a surface thereof, as is shown in FIG. 4(h). The size and the shape of the receiving portion 411 substantially match with the combination of the energy storage units 30a, 30b and 30c. Next, as shown in FIG. 4(g), the combination of the energy storage units 30a, 30b and 30c is accommodated within the receiving portion 411 of the jig tool 41, in which the first electrodes 301a, 301b and 301c (also indicated as 301 herein) are exposed.

Next, as shown in FIG. 4(j), a conductive layer 42 which is made of conductive material (e.g. solder paste) is formed on the first electrodes 301. The combination of the energy storage units 30a, 30b and 30c and the jig tool 41 are then subject to a reflow soldering process. As a result, the solder paste layer 42 is molten and then cooled to bond the first electrodes 301 together, as is shown in FIG. 4(k). Then, the combination of the energy storage units 30a, 30b and 30c, whose first electrodes 301 have been coated with the solder paste layer 42, is removed from receiving portion 411 of the jig tool 41.

Next, the combination of the energy storage units 30a, 30b and 30c is accommodated within the receiving portion 411 of the jig tool 41, in which the second electrodes 302a, 302b and 302c (also indicated as 302 herein) are exposed. Another conductive layer 42 (e.g. solder paste) is formed on the second electrodes 302. After the reflow soldering process as described above is performed, the combination of the energy storage units 30a, 30b and 30c, whose second electrodes 302 have been coated with the solder paste layer 42, is removed from receiving portion 411 of the jig tool 41. Meanwhile, a stack component 3 is fabricated, as is shown in FIG. 4(l).

It is noted that, however, those skilled in the art will readily observe that numerous modifications and alterations may be made while retaining the teachings of the invention. For example, the reflow soldering process may be replaced with a dip soldering process by immersing the first electrodes 301 and the second electrodes 302 in the molten and liquefied solder paste to form the conductive layers 42. Alternatively, the receiving portion 411 of the jig tool 41 is substantially a hollow portion. After the combination of the energy storage units 30a, 30b and 30c is accommodated within the hollow portion, the solder paste layers 42 may be simultaneously formed on the first electrodes 301 and the second electrodes 302. Optionally, the first electrodes 301 are boned together and the second electrodes 302 are boned together by corresponding solder paste layers 42 without the adhesives 52.

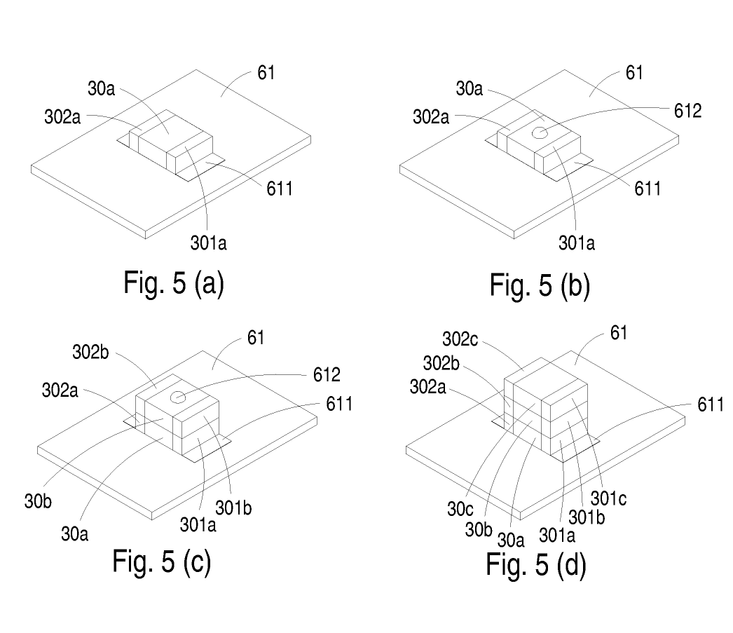

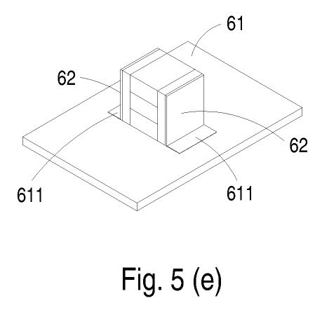

FIGS. 5(a)˜5(e) are schematic views illustrating a process of fabricating a stack component according to a third preferred embodiment of the present invention. First of all, an energy storage unit 30a and a fastening member 61 are provided. In this embodiment, the fastening member 61 is a circuit board. As shown in FIG. 5(a), the circuit board 61 has thereon two contact pads 611 corresponding to a first electrode 301a and a second electrode 302a of the energy storage unit 30a. The contact pads 611 are made of conductive material. Optionally, an adhesive (not shown) is coated on the circuit board 61 between these two contact pads 611. Likewise, the adhesive is for example made of room temperature vulcanizable (RTV) silicone rubber or phenolic formaldehyde resin.

Next, an adhesive 612 is coated on the top surface of the energy storage unit 30a and between the first electrode 301a and the second electrode 302a, as is shown in FIG. 5(b). Then, as shown in FIG. 5(c), another energy storage unit 30b is fixed on the energy storage unit 30a via the adhesive 612. Meanwhile, the first electrode 301b and the second electrode 302b of the energy storage unit 30b are contacted with the first electrode 301a and the second electrode 302a of the energy storage unit 30a. Next, an additional adhesive 612 is coated on the top surface of the energy storage unit 30b and between the first electrode 301b and the second electrode 302b. Then, as shown in FIG. 5(d), a further energy storage unit 30c is fixed on the energy storage unit 30b via the adhesive 612 such that the first electrodes 301a, 301b and 301c are contacted with each other and the second electrodes 302a, 302b and 302c are contacted with each other. The resulting structure of FIG. 5(d) is subject to an adhesive hardening process (e.g. by thermally or UV curing the adhesive) and a reflow soldering process. As a result, the energy storage units 30a, 30b and 30c are boned together and the combination thereof is fixed on the circuit board 61. Next, as shown in FIG. 5(e), two conductive layers 62 which are made of conductive material (e.g. solder paste) are formed on the first electrodes 301 and the second electrodes. In this embodiment, the combination of the energy storage units 30a, 30b and 30c is turned upside-down and the solder paste is molten and adhered onto the first electrodes 301 and the second electrodes by a wave soldering process, thereby forming the conductive layers 62. Alternatively, the conductive layers are formed on the first electrodes 301 and the second electrodes by immersing the first electrodes 301 and the second electrodes 302 in the molten and liquefied solder paste (i.e. a dip soldering process).

As previously described, the electrodes of the energy storage units need to be welded to the metallic terminals in the prior art, and the welding effect is usually undesired if the electrodes are not precisely aligned with the metallic terminals. In contrast, according to the present invention, since the energy storage units are clamped by the fastening member, the problem of causing poor solderability is overcome and the process of mounting the stack component on the circuit board is simplified. Moreover, the process of the present invention is suitable of fabricating medium- or small-sized stack components.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A process of fabricating a stack component, comprising steps of:
(a) providing multiple energy storage units having respective first electrodes and second electrodes at opposite sides, and stacking said energy storage units to have said first electrodes contact with each other and said second electrodes contact with each other, wherein said energy storage units are initially positioned by a fastening member; and
(b) bonding said first electrodes together via a first conductive layer and bonding said second electrodes together via a second conductive layer, thereby fabricating said stack component.

2. The process according to claim 1 wherein said fastening member includes a horizontal plate and at least two clamp arms, and said clamp arms are substantially perpendicular to said horizontal plate.

3. The process according to claim 2 wherein said horizontal plate is placed on a top surface of the combination of said energy storage units, and at least two sidewalls of the combination of said energy storage units are clamped by said clamp arms.

4. The process according to claim 2 wherein the step (b) includes sub-steps of:
(b1) providing a circuit board having said first conductive layer and said second conductive layer corresponding to said first electrodes and said second electrodes, respectively;
(b2) placing the combination of said energy storage units on said circuit board such that said first electrodes and said second electrodes are in contact with said first conductive layer and said second conductive layer, respectively; and
(b3) fixing the combination of said energy storage units on said circuit board by reflow-soldering said first electrodes and said second electrodes on said first conductive layer and said second conductive layer, respectively.

5. The process according to claim 4 wherein said circuit board further includes an adhesive thereon for facilitating fixing the combination of said energy storage units on said circuit board.

6. The process according to claim 1 wherein said fastening member is a jig tool having a receiving portion in a surface thereof.

7. The process according to claim 6 wherein the step (b) includes sub-steps of:
(b1) receiving the combination of said energy storage units within said receiving portion of said jig tool to initially position said energy storage units, in which said first electrodes are exposed;
(b2) dip-soldering said first conductive layer on said first electrodes;
(b3) removing the combination of said energy storage units, whose first electrodes have been bonded together via said first conductive layer, from said receiving portion of said jig tool;
(b4) receiving the combination of said energy storage units within said receiving portion of said jig tool to initially position said energy storage units, in which said second electrodes are exposed;
(b5) dip-soldering said second conductive layer on said second electrodes; and
(b6) removing the combination of said energy storage units, whose second electrodes have been bonded together via said second conductive layer, from said receiving portion of said jig tool.

8. The process according to claim 7 wherein the step (a) includes sub-steps of:
(a1) providing a base having a recess;
(a2) partially receiving a first energy storage unit in said recess of said base;
(a3) successively stacking the remaining energy storage units on said first energy storage unit to have said first electrodes contact with each other and said second electrodes contact with each other, wherein an adhesive is applied on every two adjacent energy storage units;
(a4) hardening said adhesive to initially bond said multiple energy storage units together; and
(a5) removing the combination of said energy storage units from said base.

9. The process according to claim 1 wherein said fastening member is a jig tool having a hollow portion.

10. The process according to claim 8 wherein the step (b) includes sub-steps of:
(b1) receiving the combination of said energy storage units within said hollow portion of said jig tool to initially position said energy storage units, in which said first electrodes and said second electrodes are exposed;
(b2) dip-soldering said first conductive layer and said second conductive layer on said first electrodes and said second electrodes, respectively; and
(b3) removing the combination of said energy storage units, whose first electrodes have been bonded together via said first conductive layer and said second electrodes have been bonded together via said second conductive layer, from said hollow portion of said jig tool.

11. The process according to claim 10 wherein the step (a) includes sub-steps of:
(a1) providing a base having a recess;
(a2) partially receiving a first energy storage unit in said recess of said base;
(a3) successively stacking the remaining energy storage units on said first energy storage unit to have said first electrodes contact with each other and said second electrodes contact with each other, wherein an adhesive is applied on every two adjacent energy storage units;
(a4) hardening said adhesives to initially bond said multiple energy storage units together; and
(a5) removing the combination of said energy storage units from said base.

12. The process according to claim 1 wherein said fastening member is a circuit board having a first contact pad and a second contact pad corresponding to said first electrodes and said second electrodes, respectively.

13. The process according to claim 12 wherein the step (a) includes sub-steps of:
(a1) applying an adhesive on said circuit board and between said first contact pad and said second contact pad;
(a2) fixing a first energy storage unit on said circuit board via said adhesive;
(a3) successively stacking the remaining energy storage units on said first energy storage unit to have said first electrodes contact with each other and said second electrodes contact with each other, wherein an adhesive is applied on every two adjacent energy storage units; and
(a4) hardening said adhesives to initially bond said multiple energy storage units together.

14. The process according to claim 13 wherein the step (b) includes sub-steps of:
(b1) turning the combination of said energy storage units and said circuit board upside-down; and
(b2) dip-soldering or wave-soldering said first conductive layer and said second conductive layer on said first electrodes and said second electrodes, respectively.

15. The process according to claim 1 wherein said stack component is a stack capacitor.

16. The process according to claim 15 wherein said stack component is a stack ceramic capacitor.

17. A process of fabricating a stack component, comprising steps of:
(a) providing multiple energy storage units having respective first electrodes and second electrodes at opposite sides, and stacking said energy storage units to have said first electrodes contact with each other and said second electrodes contact with each other, wherein said energy storage units are initially positioned by a fastening member;
(b) bonding said first electrodes together via a first conductive layer and bonding said second electrodes together via a second conductive layer, thereby fabricating said stack component; and
(c) removing said fastening member from said stack component.

18. The process according to claim 17 wherein said fastening member includes a horizontal plate and at least two clamp arms, and said clamp arms are substantially perpendicular to said horizontal plate.

19. The process according to claim 18 wherein said horizontal plate is placed on a top surface of the combination of said energy storage units, and at least two sidewalls of the combination of said energy storage units are clamped by said clamp arms.

20. The process according to claim 19 wherein the step (b) includes sub-steps of:
(b1) providing a circuit board having said first conductive layer and said second conductive layer corresponding to said first electrodes and said second electrodes, respectively;
(b2) placing the combination of said energy storage units on said circuit board such that said first electrodes and said second electrodes are in contact with said first conductive layer and said second conductive layer, respectively; and
(b3) fixing the combination of said energy storage units on said circuit board by reflow-soldering said first electrodes and said second electrodes on said first conductive layer and said second conductive layer, respectively.
